(19) United States
(12) Patent Application Publication
(10) Pub. No.: US 2003/0033901 A1
(43) Pub. Date: Feb. 20, 2003

(54) Cam lobe piece of built-up type camshaft

(75) Inventors: Yoshimi Sugaya, Chiba (JP); Makoto Iwakiri, Chiba (JP); Takao Mitsuno, Chiba (JP); Kou Takayama, Tokyo (JP); Hirokazu Fukagawa, Chiba (JP); Takayuki Hirao, Yokohama (JP); Kimio Nishimura, Yokohama (JP); Kouji Itakura, Kanagawa (JP); Mitsushi Oyanagi, Yokohama (JP); Yutaka Mabuchi, Yokohama (JP); Akira Fujiki, Yokohama (JP); Yukihiro Maekawa, Yokohama (JP); Yoshio Okada, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/187,434

(22) Filed: Jul. 2, 2002

(30) Foreign Application Priority Data
Jul. 3, 2001 (JP) 2001-201610
Jun. 7, 2002 (JP) 2002-166873

(51) Int. Cl. F16H 53/00

(52) U.S. Cl. 74/567

(57) ABSTRACT

A cam lobe piece of a built-up type camshaft for an internal combustion engine. The built-up type camshaft includes a hollow shaft fixedly inserted in a shaft opening of the cam lobe piece upon diametrical expansion of the hollow shaft. The cam lobe piece comprises a base circle section having the shaft opening, and a cam lobe section formed integral with the base circle section. In this cam lobe piece, the cam lobe piece is formed of a ferrous sintered material which has a density (ρ) meeting the following equation:

ρ(g/cm³)≧−⅜×t+8.9

where t is a thickness (mm) of the base circle section in radial direction.

### BACKGROUND OF THE INVENTION

This invention relates to improvements in a cam lobe piece of a built-up type camshaft functioning as an essential element of a valve operating system for an internal combustion engine, and particularly to the cam lobe piece of the built-up type camshaft arranged such that the cam lobe piece formed of a ferrous sintered material is fixedly mounted on a hollow shaft upon diametrical expansion treatment of the hollow shaft.

Hitherto built-up type camshafts have been proposed as a essential element of a valve operating system for an internal combustion engine, as disclosed in Japanese Patent Provisional Publication Nos. 8-333659, 9-31612, 11-50210 and 10-339110. The Publication Nos. 8-333659, 9-31612 and 11-50210 discuss techniques in which molybdenum is contained in a ferrous sintered alloy constituting a cam lobe or a cam lobe piece for the purpose of improving a wear resistance of the cam lobe or the cam lobe piece. The Publication No. 10-339110 discusses a technique in which heat treatment conditions are controlled so as to lower the hardness of the inner peripheral section as compared with that of the outer peripheral section of a cam lobe piece of a built-up type camshaft as a countermeasure of preventing crack from being formed during diametrical expansion of a hollow shaft inserted into a shaft opening of the cam lobe piece.

### SUMMARY OF THE INVENTION

Difficulties have been encountered in the above discussed conventional techniques as set forth below. That is, merely paying attention is made on improvements in composition of the sintered alloys in the former three Publications. However, this cannot function as the countermeasure of preventing crack formation in the cam lobe piece during the diametrical expansion of the hollow shaft of the built-up type camshaft, thus leaving room for improvement. Prevention of crack formation during the diametrical expansion of the hollow shaft is taken into consideration in the latter one Publication No. 10-339110. However, this technique is based on the premise that the cam lobe piece is formed of a material which is forged by a hot multiple stage former, and therefore does not function as the countermeasure of preventing crack formation of the cam lobe piece formed of a sintered metal, thus leaving room for improvement.

In view of the above, it is an object of the present invention to provide an improved cam lobe piece of a built-up type camshaft, which can effectively overcome drawbacks encountered in conventional metallurgical and metal forming techniques.

Another object of the present invention is to provide an improved cam lobe piece of a built-up type camshaft, which can effectively previously prevent crack from being formed in the cam lobe piece during a diametrical expansion treatment of a hollow shaft inserted into a shaft opening of the cam lobe piece, on the premise that the cam lobe piece is formed of a ferrous sintered material.

A first aspect of the present invention resides in a cam lobe piece of a built-up type camshaft having a hollow shaft fixedly inserted in a shaft opening of the cam lobe piece upon diametrical expansion of the hollow shaft. The cam lobe piece comprises a base circle section having the shaft opening, and a cam lobe section formed integral with the base circle section. In this cam lobe piece, the cam lobe piece is formed of a ferrous sintered material which has a density (ρ) meeting the following equation:

ρ(g/cm³)≧−⅜×t+8.9

where t is a thickness (mm) of the base circle section in radial direction.

A second aspect of the present invention resides in a cam lobe piece of a built-up type camshaft having a hollow shaft fixedly inserted in a shaft opening of the cam lobe piece upon diametrical expansion of the hollow shaft. The cam lobe piece comprises a base circle section having the shaft opening, and a cam lobe section formed integral with the base circle section. In this cam lobe piece, the cam lobe piece is formed of a ferrous sintered material which is formed by sintering a compact having a density ranging from 7.1 to 7.4 g/cm³.

A third aspect of the present invention resides in a method of producing a cam lobe piece of a built-up type camshaft having a hollow shaft fixedly inserted in a shaft opening of the cam lobe piece upon diametrical expansion of the hollow shaft, in which the cam lobe piece includes a base circle section having the shaft opening, and a cam lobe section formed integral with the base circle section. The method comprises (a) compacting ferrous power material to form a compact; and (b) sintering the compact to form a ferrous sintered material having a density (ρ) meeting the following equation:

ρ(g/cm³)≧−⅜×t+8.9

where t is a thickness (mm) of the base circle section in radial direction.

A fourth aspect of the present invention resides in a method of producing a cam lobe piece of a built-up type camshaft having a hollow shaft fixedly inserted in a shaft opening of the cam lobe piece upon diametrical expansion of the hollow shaft, in which the cam lobe piece includes a base circle section having the shaft opening, and a cam lobe section formed integral with the base circle section. The method comprises (a) compacting ferrous power material to form a compact having a density ranging from 7.1 to 7.4 g/cm³; and (b) sintering the compact to form a ferrous sintered material for the cam lobe piece.

### BRIEF DESCRIPTION OF DRAWINGS

FIG. 1A is a side view of each of first and second embodiments of a cam lobe piece according to the present invention;

FIG. 1B is a cross-sectional view of the cam lobe piece of FIG. 1A;

FIG. 2 is a graph showing comparison in effect between conventional compacting and warm compacting in terms of relationship between the compacting load and the density of compacts; and

FIG. 3 is a graph showing the relationship between the tensile strength and the density of a sintered material after sintering.

### DETAILED DESCRIPTION OF THE INVENTION

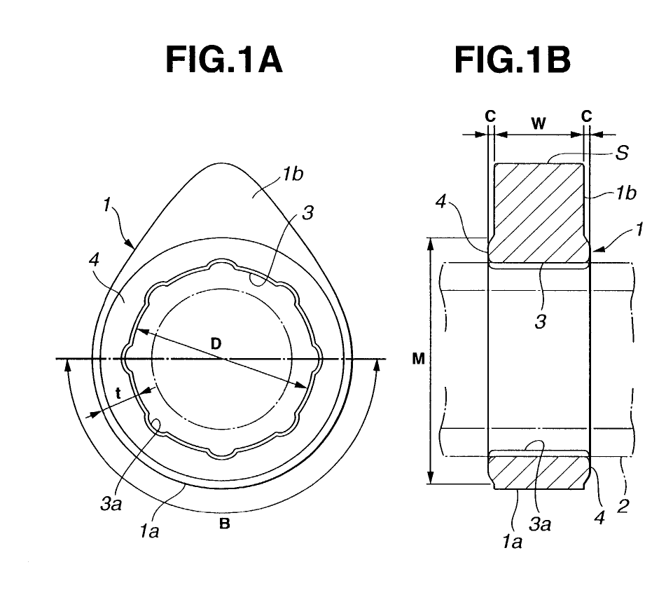

Referring now to FIGS. 1A and 1B, a first embodiment of a cam lobe piece according to the present invention is illustrated by the reference numeral 1. Cam lobe piece 1 is of a built-up type camshaft which has cylindrical hollow shaft 2 fixedly inserted in shaft opening 3 of the cam lobe piece upon diametrical expansion of the hollow shaft. The cam lobe piece comprises annular base circle section 1a having the shaft opening, and cam lobe section 1b formed integral with the base circle section. Cam lobe piece 1 is formed of a ferrous sintered material which has a density (ρ) meeting the following equation:

ρ(g/cm³)≧−⅜×t+8.9 Eq. (1)

where t is a thickness (mm) of the base circle section in radial direction. In other words, t is the thickness of a part of annular base circle section 1a indicated by B in FIG. 1A. The built-up type camshaft of this case is for an automotive internal combustion engine.

More specifically, cam lobe piece 1 is generally annular and includes annular base circle section 1a corresponding to the base circle of cam lobe piece 1. Cam lobe section 1b having a cam lobe (not identified) is formed integral with base circle section 1a. Base circle section 1a is formed with circular shaft opening 3 which is coaxial with base circle section 1a. Cylindrical hollow shaft 2 made of steel or the like is fixedly inserted in the shaft opening 3 to be generally coaxial with base circle section 1a in the following manner: Hollow shaft 2 is inserted into shaft opening 3 of base circle section 1a such that the axes of hollow shaft 2 and base circle section 1a are aligned with each other. Then, hollow shaft 2 is diametrically expanded, for example, by using a mandrel so that the outer peripheral surface of shaft 2 is pressed to the inner peripheral surface of the base circle section 1a, in which the mandrel is applied to the inner peripheral surface of hollow shaft 2. Cam lobe piece 1 is formed of a ferrous sintered material (alloy).

The ferrous sintered material of cam lobe piece 1 will be discussed in detail hereinafter.

As a result of precise measurement and analysis of stress in the cam lobe piece during diametrical expansion (treatment) of the shaft, the present inventors have found that crack formation or no crack formation in the cam lobe piece during the diametrical expansion of the hollow shaft depends on whether the expansion of the material of the cam lobe can follow stress generated in the cam lobe piece or not. It has been apparent from the analysis that the composition and density of the material largely affect the elongation of the material, so that the crack resistance of the cam lobe piece can be largely improved by regulating the above two factors (the composition and the density). Furthermore, it has been found that the thickness of the base circle section of various dimensions of the cam lobe piece is the factor which the most affects stress produced in the cam lobe piece. Additionally, it has been experimentally found that there is a region in which no crack is formed by fixing the material composition and by setting the material density at a value not less than a certain value which is calculated from the thickness of the base circle section even under a condition in which the thickness of the base circle section should be small according to the overall dimensional restriction of the cam lobe piece.

The value of the material density of the cam lobe piece will be discussed in detail hereinafter. The cam lobe piece is formed of a ferrous sintered material which has the material density (ρ) obtained after sintering, meets the relationship of the equation Eq. (1).

The material composition of the cam lobe piece preferably can provide a certain required density even under normal sintering conditions merely by meeting the above equation Eq. (1). For example, according to a 2P2S (double pressing and double sintering) method, a sinter forging method or the like, the certain required density can be obtained not according to the composition; however, these methods are high in cost and therefore less in merit. In view of this, it is possible to meet the above equation Eq. (1) under a standard sintering condition of 1120° C. with the material composition within a regulated range in which the ferrous sintered material consists essentially of C in an amount of from 0.3 to 0.8% by weight, Mo in an amount of from 1.2 to 1.8% by weight and a balance being Fe and inevitable impurities. With this regulated range, an elongation (of the material) endurable to crack formation during the diametrical expansion of the hollow shaft can be obtained by an economical method as compared with using conventional cam lobe piece materials containing large amounts of components such as Mo, C, Ni, Cu and the like.

The above contents (amounts) of the components of the ferrous sintered material are determined for the reasons set forth below. A good wear resistance can be secured by setting the C content of not less than 0.3% by weight, whereas the material is embrittled to degrade the crack resistance of he material if the C content exceeds 0.8% by weight. Additionally, a good matrix strength of the material can be obtained by setting the Mo content of not less than 1.2% by weight, whereas merit in cost is lost if the Mo content exceeds 1.8% by weight. The ferrous sintered material is preferably formed of power material containing Fe, Mo and Ni. The powder material contains fully alloyed Fe—Mo powder, in which Ni is partially alloyed with the fully alloyed Fe—Mo powder, i.e., Ni particle is diffusion-bonded to the Fe—Mo alloy powder.

The density of the ferrous sintered material of the cam lobe piece is regulated as represented by the above equation Eq. (1). In case that the density is within a range represented by the equation Eq. (1), crack formation of the cam lobe piece can be prevented during the diametrical expansion (treatment) of the hollow shaft while making it unnecessary to raise the density of the material upon unnecessary rise in cost for the material, thus realizing provision of the camshaft high in quality and low in cost. In this regard, the density of not lower than 6 g/cm³ is preferable to suppress an enlargement of the overall dimension of the camshaft while securing a suitable outer diameter of the hollow shaft of the camshaft.

Further, as a result of analysis of measures for obtaining the certain required density of the cam lobe piece without an excessive rise in temperature of a die and tools, it has been found that addition of Ni in an amount of not less than 1.7% by weight to the ferrous sintered material of the cam lobe piece promotes liquid phase sintering to raise an inter-particle strength thereby obtaining the certain required density. This method can suppress a cost-up without unnecessary rise in temperature of the die and tools. However, if Ni is added in an amount exceeding 2.3% by weight, a cost is increased while degrading the wear resistance owing to increase of retained austenite. Thus, the cam lobe piece is preferably formed of the ferrous sintered material which consists essentially of C in an amount of from 0.3 to 0.8% by weight, Ni in an amount of from 1.7 to 2.3% by weight, Mo in an amount of from 1.2 to 1.8% by weight and a balance being Fe.

The cam lobe piece has a cam lobe outer surface S to which a cam follower (e.g., a valve lifter) (not shown) is contactable. The cam outer surface has a hardness of not lower than 60 HRA (Rockwell hardness, A-scale) which is obtained upon a heat treatment of the material of the cam lobe piece. This remarkably improves the wear resistance of the cam lobe surface S of the cam lobe piece.

Furthermore, as a result of analysis of coefficients correlative to friction of ferrous sintered materials, it has been found that a surface roughness represented as Rpk according to JIS (Japanese Industrial Standard) B 0651 is highly correlative to friction in case of sintered materials, as compared with a surface roughness represented as Ra according to JIS B 0601 used in case of conventional molten metals or materials. Here, it has been found that friction between the cam lobe piece and the valve lifter is reduced by setting a Rpk of not smaller than 0.1 μm. Additionally, employing Rpk in grinding the material can previously prevent an increase in processing or machining cost as compared with employing Ra in grinding the material in conventional machining. Thus, Rpk of the material of the cam lobe piece is set to be not larger than 0.1 μm.

Furthermore, as a result of analysis of relation between the density of the ferrous sintered material of the cam lobe piece and the friction, it has been found that the friction largely changes depending on whether the porosity of the material is open porosity or isolated porosity. More specifically, in case that the material has the isolated porosity at the density of not lower than 7.25 g/cm³, oil is kept in isolated pores located immediately under the sliding surface (or the cam outer surface) of the cam lobe piece thereby maintaining a suitable oil pressure at a contact section where the cam lobe piece is in contact with the valve lifter, thus providing a good lubricating condition. It will be understood that the isolated pores are exposed at the cam outer surface S of the cam lobe piece. In contrast, in case that the material has the open porosity, oil cannot be kept in open pores located immediately under the sliding surface, metallic contact is increased at the contact section thereby degrading the lubricating function. Accordingly, the density of the material of the cam lobe piece is regulated to be not lower than 7.25 g/cm³ in the ferrous sintered material of the isolated porosity.

It has been also found preferable that the good oil pressure can be maintained at the contact section by impregnating the pores exposed at the cam outer surface with synthetic resin or plastic even without setting the density of the material to be not lower than 7.25 g/cm³. The synthetic resin prevents lubricating oil from penetrating into the material. Examples of the synthetic resin are Resinol 90C which is the trade name of a product of Henkel and whose main ingredient is methacrylate, and PAI (polyamideimide).

In order to further improve the friction characteristics of the cam lobe piece, it is preferable that the above synthetic resin contains solid lubricant in a dispersed condition, and that the pores exposed at the cam outer surface is impregnated with the synthetic resin in which the solid lubricant is dispersed. This provides the effect of largely reducing the friction of the cam lobe piece to the valve lifter in addition to the effect of preventing oil from penetrating into the material. Examples of the solid lubricant are MoS₂, PTFE (polytetrafluoroethylene) and graphite.

### EXPERIMENT 1

The first embodiment of the present invention will be more readily understood with reference to the following Examples in comparison with Comparative Example; however, these Examples are intended to illustrate the invention and are not to be construed to limit the scope of the invention.

### EXAMPLE 1-1

Powder material containing 2.0% by weight of Ni, 1.5% by weight of Mo, 0.6% by weight of C and the balance of Fe and inevitable impurities was prepared. The powder material was subjected to warm compacting in which the powder material and a die and tools were heated at 100° C., thereby obtaining a compact. The compact underwent sintering at a sintering temperature of 1120° C. in the atmosphere of modified butane gas, thereby obtaining a sintered compact. Then, the sintered compact was subjected to carburizing hardening at a temperature of 900° C., followed by tempering at a temperature of 180° C., thus producing a ferrous sintered material (cam lobe piece) having an actually measured density of 7.33 g/cm³ and a base circle section thickness (t) of 4.5 mm.

### EXAMPLE 1-2

A procedure of Example 1-1 was repeated with the exception that the warm compacting was carried out in such a manner that the produced ferrous sintered material (cam lobe piece) had an actually measured density of 7.17 g/cm³ and a base circle section thickness (t) of 5.6 mm.

### EXAMPLE 1-3

A procedure of Example 1-2 was repeated with the exception that pores exposed at the cam outer surface (S) of the cam lobe piece were impregnated with the synthetic resin (Resinol 90C).

### EXAMPLE 1-4

A procedure of Example 1-3 was repeated with the exception that pores exposed at the cam outer surface (S) of the cam lobe piece were impregnated with synthetic resin (polyamideimide) in which solid lubricant (MoS₂) was dispersed in an amount of 40 % by volume of the synthetic resin.

### COMPARATIVE EXAMPLE 1-1

Powder material containing 3.0 % by weight of Cu, 0.6% by weight of C and the balance of Fe was prepared. The powder material were subjected to warm compacting in which the powder and a die and tools were heated at 130° C., thereby obtaining a compact. The compact underwent sintering at a sintering temperature of 1120° C. in the atmosphere of modified butane gas, thereby obtaining a sintered compact. Then, the sintered compact was subjected to carburizing hardening at a temperature of 900° C., followed by tempering at a temperature of 180° C., thus producing a ferrous sintered material (cam lobe piece) having an actually measured density of 7.01 g/cm³ and a base circle section thickness of 4.5 mm.

### EVALUATION TEST

Evaluation tests were conducted on the cam lobe pieces of Examples and Comparative Example to evaluate performance of the cam lobe pieces. The evaluation tests were as follows:

(1) Hardness

The hardness of the cam outer surface (S) of each cam lobe piece was measured in terms of Rockwell hardness (A-scale). The result of this measurement is shown as “Hardness HRA” in Table 1.

(2) Surface Roughness

The surface roughness of the cam outer surface of each cam lobe piece obtained after surface finishing was measured in terms of Rpk (according to JIS B 0651). The result of this measurement is shown as “Surface roughness Rpk (μm)” in Table 1.

(3) Expansion Test

Each cam lobe piece was mounted on a steel hollow shaft in such a manner that the hollow shaft was inserted into the shaft opening of the cam lobe piece. A hollow shaft was diametrically expanded by using a mandrel at a diametrical expansion rate of 3.3%, in which observation was made with a stereomicroscope to inspect as to whether crack was formed in the cam lobe piece or not. The diametrical expansion rate was represented by “(A−B)/B” where A is the outer diameter of hollow shaft before the diametrical expansion; and B is the outer diameter of hollow shaft before the diametrical expansion. The result of this observation is shown as “Expansion test” in Table 1.

(4) Wear Test

Each cam lobe piece was fixedly mounted on a shaft which was to be driven. A valve lifter was disposed in press contact with the cam outer surface (S) of the cam lobe piece under the bias of a valve spring. The valve lifter was provided with a shim formed of chromium molybdenum steel (SCM 420 according to JIS G 4105) which had been subjected to carburizing hardening and soft-nitriding with gas. The shim was in slidable contact with the cam outer surface of the cam lobe piece. With a thus set test apparatus, wear test was conducted as follows: The shaft on which the cam lobe piece was fixedly mounted was driven at 300 r.p.m. for 24 hours under conditions in which the maximum load applied to the cam lobe piece through the valve lifter was 130 kgf; the temperature of oil to be supplied to the cam outer surface (S) of the cam lobe piece was 79.9° C.; and the amount of oil flow to be supplied to the cam outer surface was 810 cc/min. After completion of this test, an wear amount (μm) of the cam lobe piece was measured. The result of this measurement is shown as “Wear amount (μm)” in Table 1.

(5) Friction Test

A procedure of the above wear test was repeated with the exception that the shaft on which the cam lobe piece was fixedly mounted was driven for 1 hour, in which friction torques (kg-cm) were measured. Then, an average value of the measured friction torques was obtained as the test result which is shown as “Friction torque (kg-cm)” in Table 1.

In Table 1, “Composition (wt %)”, “Impregnation treatment”, “Density (g/cm³)”, “Thickness of base circle section (mm)” and “Lower limit of density (g/cm³)” of each of the cam lobe pieces of Examples and Comparative Example are also shown in addition to the test results of the above evaluation tests. The density was measured according to JIS Z 2501. The thickness of base circle section was a radial thickness (“t” indicated in FIG. 1A) of base circle section 1a. The lower limit of density (ρ) was calculated according to the equation of ρ (g/cm³)=−⅜ ×t+8.9.

As apparent from the test results in Table 1, the cam lobe piece of Example 1-1 has the actually measured density of 7.33 g/cm³ and the base circle section thickness (t) of 4.5 mm. The cam lobe piece of Example 1-2 has the actually measured density of 7.17 g/cm³ and the base circle section thickness (t) of 5.6 mm. Accordingly, the actually measured densities exceed respectively the corresponding theoretical densities (lower limit of density), and therefore no crack is formed in the cam lobe pieces of Examples 1-1 and 1-2. The cam lobe pieces of Examples 1-1 and 1-2 have the hardness of not lower than 60 HRA upon being subjected to the heat treatment in the above-discussed manner. Both the cam lobe pieces of Examples 1-1 and 1-2 exhibit a high wear resistance as compared with that of Comparative Example 1-1. Additionally, the cam lobe pieces of Examples 1-1 and 1-2 have the surface roughness Rpk (μm) of not higher than 0.1, and therefore they are largely improved in surface roughness over the cam lobe piece of Comparative Example 1-1.

The cam lobe piece of Example 1-1 has the actually measured density of not lower than 7.25 g/cm³, whereas the cam lobe piece of Example 1-2 has the actually measured density of lower than 7.25 g/cm³, so that the latter cam lobe piece is higher in friction torque (kg-cm) than that the former cam lobe piece. The cam lobe piece of Example 1-3 is impregnated at its cam outer surface (S) with the synthetic resin, and therefore exhibits a higher wear resistance. The cam lobe piece of Example 1-4 is impregnated at its cam outer surface (S) with the synthetic resin in which solid lubricant is dispersed, and therefore exhibits a much higher wear resistance.

As discussed above, it has been confirmed that all the cam lobe pieces of Examples 1-1, 1-2, 1-3 and 1-4 have excellent crack resistance (during diametrical expansion of the hollow shaft), wear resistance and friction characteristics, as compared with the cam lobe piece of Comparative Example 1-1.

Next, a second embodiment of the cam lobe piece according to the present invention will be discussed. The cam lobe piece of this embodiment is the same in shape as the first embodiment cam lobe piece, and therefore the discussion will be made with reference to FIGS. 1A and 1B.

Cam lobe piece 1 is of a built-up type camshaft which has hollow shaft 2 fixedly inserted in shaft opening 3 of the cam lobe piece upon diametrical expansion of the hollow shaft. Cam lobe piece 1 comprises base circle section 1a having the shaft opening, and cam lobe section 1b formed integral with said base circle section. Cam lobe piece 1 is formed of a ferrous sintered material which is formed by sintering a compact having a density ranging from 7.1 to 7.4 g/cm³.

Cam lobe piece 1 is produced as follows: Metal powder material of the Fe—Cu—C system is compacted to form a compact of the shape having a certain cam profile, under the warm compacting. This compact is sintered, followed by a heat treatment including carburizing hardening and tempering. During the warm compacting, circular shaft opening 3 is formed including a plurality of axially extending depressions 3a. Hollow shaft 2 (serving as the opposite member) formed of steel or the like is to be inserted into shaft opening 3 of cam lobe piece 1. Additionally, during the warm compacting, annular projections 4 are formed respectively at opposite side surfaces (axial end faces) of base circle section 1a. Annular projections 4 are coaxial with the base circle of cam lobe piece 1 and with the circular shaft opening 3. Each annular projection 4 is located radially inside of the base circle of cam lobe piece 1 and has a slight height C in axial direction.

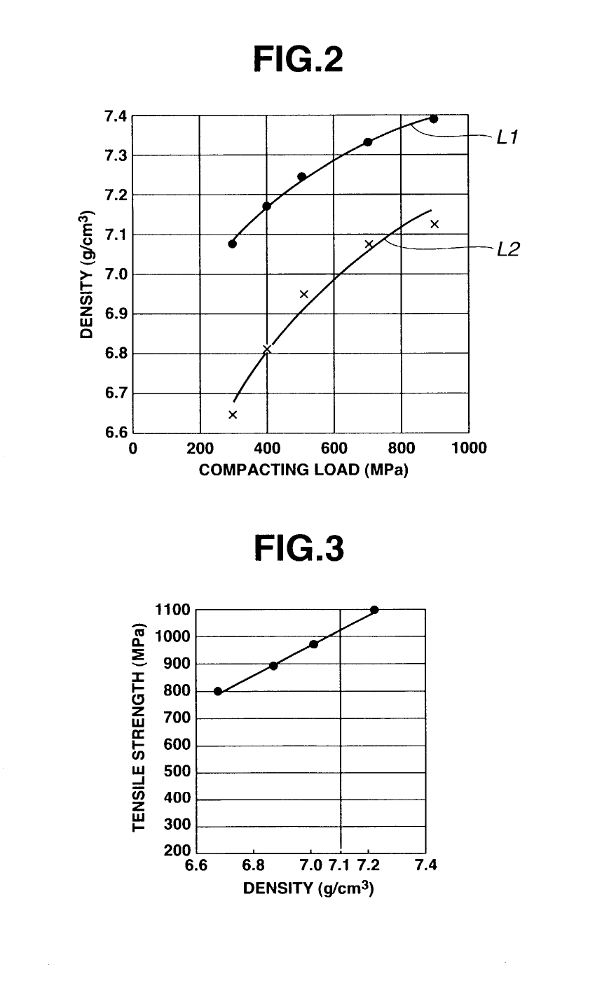

In the warm compacting, the metal power material is compacted to form the compact under a condition in which the metal powder material and the die and tools are heated at a temperature around 130° C. The warm compacting is characterized in that densification of the cam lobe piece can be further promoted as compared with conventional compacting at ordinary temperatures, as will be discussed after with reference to FIG. 2. In this embodiment, the warm compacting is made to form the compact having the density ranging from 7.1 to 7.4 g/cm³.

The metal powder material of the Fe—Cu—C system to be subjected to the warm compacting has preferably a composition consists essentially of Cu in an amount ranging from 1.5 to 4.0% by weight, C in an amount ranging from 0.7 to 1.0% by weight, and the balance being Fe and inevitable impurities. Cu contents lower than 1.5% by weigh and higher than 4.0% by weight are not preferable as discussed in detail after. The metal powder material more preferably has a Cu content ranging from 2.0 to 3.0% by weight.

The sintering (treatment) following the compacting is carried out in the atmosphere of modified butane gas at a temperature of 1120° C. The heat treatment after the sintering is carried out on the sintered compact, as follows: Carburizing is made at a carburizing temperature of 900° C., and then oil hardening is made at a temperature of 60° C. Thereafter, tempering (treatment) is made at a temperature of 180° C.

The tensile strength of the cam lobe piece after the heat treatment is improved generally in proportion to the density of the cam lobe piece as depicted in FIG. 3 which shows the experimentally determined relationship between the tensile strength and the density of the sintered material after sintering. For example, the tensile strength of the sintered material reaches not lower than 1030 MPa in case of the density of 7.1 g/cm³.

Cam lobe piece 1 completed upon being subjected to the above heat treatment is mounted on hollow shaft 2 (for example, formed of steel) by inserting hollow shaft 2 into shaft opening 3a of cam lobe piece 1, followed by accomplishing a relative positioning between the cam lobe piece and the hollow shaft. Thereafter, a mandrel is forced into the hollow of hollow shaft 2 to diametrically expand hollow shaft 2 at a diametrical expansion rate of about 3.3% so as to fixedly secure the cam lobe piece on the hollow shaft. The diametrical expansion rate is represented by “(A−B)/B” where A is the outer diameter of hollow shaft 2 before the diametrical expansion; and B is the outer diameter of hollow shaft 2 before the diametrical expansion.

Hereinafter, the principle of the second embodiment of the cam lobe piece according to the present invention will be discussed.

The ferrous sintered material of the cam lobe piece is formed by making the warm compacting of the powder material, followed by sintering so as to obtain the density ranging from 7.1 to 7.4 g/cm³. The ferrous sintered material is then subjected to heat treatments such as hardening and tempering. The ferrous sintered material (compact) consists essentially of Cu in an amount of from 1.5 to 4.0% by weight, C in an amount of from 0.7 to 1.0% by weight and the balance being Fe and inevitable impurities.

The cam lobe piece is improved in mechanical properties such as tensile strength obtained after the heat treatments by increasing the density of the ferrous sintered material to a value of not lower than 7.1 g /cm³. For example, the cam lobe piece can be sufficiently endurable to stress generated at the side of the cam lobe piece during the diametrical expansion of the hollow shaft upon using a mandrel, so that formation of crack in the cam lobe piece can be effectively prevented. Additionally, the warm compacting is employed for a measure of raising the density, in which compacting of the power material is accomplished upon heating the power material and a die and tools at a temperature around 130° C. As a result, the density of the ferrous sintered material can be raised to a range of from 7.1 to 7.4 g/cm³ without accompanying economical disadvantages. Particularly, a wear resistance required for the cam lobe piece can be sufficiently obtained on the fact that the ferrous sintered material (compact) consists essentially of Cu in an amount of from 1.5 to 4.0% by weight, C in an amount of from 0.7 to 1.0% by weight and the balance being Fe and inevitable impurities.

Here, a cam lobe piece produced by a method using sintering is high in dimensional precision and therefore suitable for application to the built-up type camshaft. However, in case that the cam lobe piece is fixed on the hollow shaft by diametrically expanding the hollow shaft upon using a mandrel, there is a possibility that the cam lobe piece (formed of a conventional ferrous sintered material) produces its crack since considerably large internal stress is generated in the cam lobe piece, thereby making it difficult to put such a cam lobe piece into practical use. In order that the cam lobe piece is endurable to the internal stress generated during the diametrical expansion of the am lobe piece, it is assumed to employ conventional methods for raising the density of the cam lobe piece itself by repeating compacting and sintering in the order of compacting, preliminary sintering, re-compacting and main sintering, or by carrying out sinter forging or the like. However, any of such conventional methods largely increase the number of production steps thereby unavoidably raising production cost of the built-up type camshaft.

In recent years, the warm compacting has been tried in which compacting is accomplished upon heating the powder material (for the sintered material) and the die and tools at a temperature around 130° C., thereby being intended to obtain a high density sintered material without accompanying an increase in number of production steps. In other words, as show in FIG. 2, the upper limit of the density of a compact (before sintering) is around 7.1 g/cm³ in case that compacting is made at ordinary temperature as conventionally widely carried out, as indicated by a line L2 in FIG. 2 which shows the relationship between the density of the compact and the compacting load which is a load applied during compacting. In contrast, the density of the compact (before sintering) can be raised to around 7.4 g/cm³ in case of using the warm compacting as indicated by a line L1 in FIG. 2. In view of this, it is preferable for the present invention to employ this warm compacting. It will be understood that raising the density largely over 7.4 g/cm³ is difficult under industrial production conditions, and therefore the range of the density of the sintered material is regulated to be from 7.1 to 7.4 g/cm³.

The mechanical properties, particularly the tensile strength, of the sintered material are highly correlative to the density, so that the tensile strength increases generally in proportional to the raised density. For example, the tensile strength reaches a value of not lower than 1000 MPa in case that the density of the sintered material is 7.1 g/cm³. As a result, it has been confirmed that the stress generated on the side of the cam lobe piece becomes lower than the tensile strength when the hollow shaft inserted into the shaft opening of the cam lobe piece is, for example, diametrically expanded by the mandrel in order to fixing the cam lobe piece formed of the ferrous sintered material onto the hollow shaft serving as an opposite side member, so that the cam lobe piece and the hollow shaft are securely fixed to each other upon making the diametrical expansion of the hollow shaft without inviting crack formation in the cam lobe piece.

The cam lobe piece is produced as follows: The powder material is compacted to form the compact having a certain shape under the warm compacting. The compact is sintered at a sintering temperature of not lower than 1080° C. so as to form the sintered compact. Thereafter, the sintered compact is subjected to a heat treatment including carburizing hardening and tempering, or another heat treatment including induction hardening and tempering. Although a characteristics of raising the strength by raising the density is common to a variety of materials other than the material of the present invention, it is preferable to select the components to be contained in the ferrous sintered material for the purpose of ensuring required mechanical strengths while economically producing the ferrous sintered alloy.

For example, ferrous sintered materials containing Cr have been widely used for conventional cam lobe pieces; however, it is preferable not to contain Cr because atmospheres for sintering and for heat treatment are limited to particular ones in order to prevent crystal boundary oxidation if Cr is contained. Concerning Ni, if the ferrous sintered material contains not less that 2% by weight of it, much retained austenite are precipitated and therefore an excessive Ni content is not preferable from the viewpoint of improving wear resistance.

The sintered material of Fe—Cu—C system contains no expensive alloy element and is the most general material. Cu is effective for reinforcing the matrix and improving the strength of the sintered material. If the content of Cu is not more than 1.5% by weight, a desired effect cannot be obtained. If the content of Cu exceeds 4.0% by weight, the sintered material will make its embrittlement while making its dimensional expansion during sintering. Thus, an excessive content of Cu is not preferable, and therefore the content of Cu is preferably within a range of from 1.5 to 4.0% by weight, more preferably within a range of from 2.0 to 3.0% by weight.

C functions to form a solid solution with the matrix thereby improving the strength of the sintered material, and is an essential element on the assumption that hardening treatment is applied to the sintered material. The texture of the sintered material obtained after hardening is constituted of martensite and fine pearlite, in which the C content of not less than 0.7% by weight is effective for obtaining a sufficient martensite texture for parts (such as the cam lobe piece) which require a good wear resistance characteristics. However, if the C content exceeds 1.0% by weight, embrittlement of the sintered material will occur while the compressibility of the power material during compacting will be degraded thereby making it impossible to raise the density of the sintered material. Thus, the C content is set within the range of from 0.7 to 1.0% by weight.

As shown in FIG. 1B, cam lobe piece 1 has a thickness or axial thickness dimension W of not less than 5 mm. Additionally, annular projections 4 are formed respectively at opposite side surfaces (axial end faces) of base circle section 1a and coaxial with the base circle of cam lobe piece 1 and with the circular shaft opening 3. Each annular projection 4 is located radially inside of the base circle of cam lobe piece 1. Annular projections 4 are formed during the warm compacting of cam lobe piece 1.

With the above thickness of cam lobe piece 1, it is sufficient that the minimum thickness (axial thickness dimension) W of the cam lobe piece is 5 mm. As a result of this thickness, contributions are made on weight-lightening of the engine, reduction of friction and improvement in freedom in engine design, while contributing to lowering in production cost of the cam lobe piece itself. In other words, the cam lobe piece to be used in the automotive engine is desired to be reduced in thickness (axial thickness dimension of the cam lobe piece itself) as small as possible to meet weight-lightening of the engine itself and reduction of friction. In this regard, the internal stress generated in the cam lobe piece during the diametrical expansion (treatment) increases as the thickness of the cam lobe piece decreases, and therefore it is disadvantageous from the viewpoint of strength to reduce the thickness of the cam lobe piece. However, it has been confirmed that the tensile strength of the sintered material overcomes the internal stress generated during the diametrical expansion thereby preventing crack formation of the cam lobe piece during the diametrical expansion if the thickness of 5 mm of the cam lobe piece can be secured in minimum.

With the above feature of annular projections 4, the area of the inner peripheral surface of the cam lobe piece increases as compared with the outer peripheral surface, and therefore a contribution is relatively effectively made on reduction of the stress generated during the diametrical expansion (treatment) of the cam lobe piece while suppressing an increase in weight of the cam lobe piece and in sliding surface area at which the cam lobe piece is in sliding contact with the valve lifter as an opposite member. More specifically, by virtue of locally forming the annular projections in the cam lobe piece, a weight-increase of the cam lobe piece can be suppressed while preventing an increase in friction between the cam lobe piece and the valve lifter (a kind of cam follower as the opposite member) as compared with an assumptive case in which the whole thickness of the cam lobe piece is increased. Additionally, since the annular projections are formed during the warm compacting, machining such as cutting for forming the annular projections becomes unnecessary. It has been confirmed that stress generated during the diametrical expansion of the hollow shaft reduces by about 5% merely by forming annular projections 4 having the height C of about 0.5 mm at the opposite side surfaces of base circle section 1a of cam lobe piece 1 in case that cam lobe piece 1 has the thickness W of 12.5 mm.

As apparent from the above, by applying the heat treatment onto the ferrous sintered material of the cam lobe piece, the resultant cam lobe piece is largely improved in mechanical strength such as tensile strength thereby securely preventing crack from being formed in the cam lobe piece during the diametrical expansion treatment of the hollow shaft inserted into the shaft opening of the cam lobe piece. In case that the heat treatment includes the hardening and the tempering, the effect of preventing crack formation can become further conspicuous.

### EXPERIMENT 2

The second embodiment of the present invention will be more readily understood with reference to the following Examples in comparison with Comparative Examples; however, these Examples are intended to illustrate the invention and are not to be construed to limit the scope of the invention.

### EXAMPLE 2-1

Metal powder material of the Fe—Cu—C system containing 3.0% by weight of Cu and 0.8% by weight of C and the balance of Fe and inevitable impurities was prepared. The metal powder material was subjected to warm compacting in which the power and a die and tools were heated, thereby obtaining a compact having a density of 7.1 g/cm³. The compact underwent sintering at a sintering temperature of 1120° C. in the atmosphere of modified butane gas, thereby obtaining a sintered compact. Then, the sintered compact was subjected to carburizing (treatment) at a carburizing temperature of 900° C., followed by oil hardening at a temperature of 60° C. Thereafter, the sintered compact was subjected to tempering (treatment) at a temperature of 180° C., thus producing a sintered material (cam lobe piece).

### EXAMPLE 2-2

A procedure of Example 2-1 was repeated with the exception that the warm compacting was carried out in such a manner as to form a compact having a density of 7.2 g/cm³, thus producing a sintered material (cam lobe piece).

### COMPARATIVE EXAMPLE 2-1

A procedure of Example 2-1 was repeated with the exception that the warm compacting was carried out in such a manner as to form a compact having a density of 6.7 g/cm³, thus producing a sintered material (cam lobe piece).

### COMPARATIVE EXAMPLE 2-2

A procedure of Example 2-1 was repeated with the exception that the prepared powder material of the Fe—Cu—C system contained 3.0% by weight of Cu and 0.5% by weight of C and the balance of Fe and inevitable impurities, thus producing a sintered material (cam lobe piece).

The cam lobe pieces of Examples 2-1 and 2-2 and Comparative Examples 2-1 and 2-2 had the shape shown in FIGS. 1A and 1B and had the following dimensions: The thickness W was 12.5 mm; the diameter D of shaft opening 3 was 18.2 mm; the maximum diameter M of annular projection 4 was 34 mm; the height C of annular projection 4 was 0.5 mm; and the thickness t of base circle section 1a was 5.65 mm.

### EXAMPLE 2-3

A procedure of Example 2-1 was repeated with the exception that the produced sintered material (cam lobe piece) had the thickness W of 10 mm.

### EXAMPLE 2-4

A procedure of Example 2-1 was repeated with the exception that the produced sintered material (cam lobe piece) had the thickness W of 7 mm.

### EXAMPLE 2-5

A procedure of Example 2-1 was repeated with the exception that the produced sintered material (cam lobe piece) had the thickness W of 5 mm.

### EVALUATION TEST

In order to evaluate performance of the cam lobe pieces of Examples 2-1 and 2-2 in comparison with those of Comparative Examples 2-1 and 2-1, the hardness, density, tensile strength and wear amount ratio were measured and shown in Table 2 in which the composition, sintering temperature and heat treatment described above were also shown. The hardness, density, tensile strength and wear amount ratio were measured as follows:

(1) Hardness

The hardness of the cam outer surface (S) of each cam lobe piece was measured in terms of Rockwell hardness (A-scale). The result of this measurement is shown as “Hardness HRA” in Table 2.

(2) Density

The density of the compact (before sintering) for each cam lobe piece was measured according to JIS Z 2505. The result of this measurement is shown as “Density (g/cm³)” in Table 2.

(3) Tensile Strength

The tensile strength of each cam lobe piece was measured according to JIS Z 2201. The result of this measurement is shown as “Tensile strength (Mpa) in Table 2.

(4) Wear Amount Ratio

A wear test was conducted by using a block-on-ring wear test apparatus. For this wear test, the specimen of each cam lobe piece was set in the test apparatus in a manner to be pressed against a ring-shaped mating material (having an outer diameter of 0.035 m) dipped in automotive engine oil, at a load of 38200 N/m. The mating material was heat-treated chrome molybdenum steel. The wear test was made by rotating the ring-shaped mating material at a friction speed of 5.3 m/sec. so as to accomplish friction of the specimen to the mating material for a time corresponding to a total friction distance of 57000 m. After completion of the wear test, the wear amount of the specimen of the cam lobe piece was measured. The test result is indicated as “Wear amount ratio” in Table 2. The wear amount ratio is a ratio of the wear amount of the cam lobe piece to the wear amount of the cam lobe piece of Example 2-1 on the assumption that the wear amount of cam lobe piece of Example 2-1 is 1.

Additionally, in order to evaluate performance of the cam lobe pieces of Examples 2-1, 2-3, 2-4 and 2-5, stress generated in each cam lobe piece was measured during the diametrical expansion (treatment) of the cam lobe piece and shown in Table 3 in which the thickness W, the density (measured as discussed above) and the generated stress are also shown. The generated stress was measured as follows:

(5) Generated Stress

Each cam lobe piece was mounted on a steel hollow shaft in such a manner that the hollow shaft was inserted into the shaft opening of the cam lobe piece. The hollow shaft was diametrically expanded by using a mandrel at the diametrical expansion rate of 3.3%, in which the internal stress generated in cam lobe piece 1 was measured by using a strain gauge. The result of this measurement is shown as “Generated stress (MPa)” in Table 3.

As apparent from the test results in Table 2, both the cam lobe pieces of Examples 2-1 and 2-1 are low in wear amount ratio and excellent in tensile strength, and therefore it has been confirmed that they meet expected requirements. In contrast, the cam lobe piece of Comparative Example 2-1 is low in density obtained upon the compacting is low so as not to be able to obtain a sufficient tensile strength even after the sintering and the heat treatment. The cam lobe piece of Comparative Example 2-1 is less in the C content so as to be high in wear amount ratio as 1.7, and therefore is problematic in wear resistance.

As apparent from the test results in Table 3, the internal stress generated in the cam lobe piece of Example 2-1 is smaller than the tensile strength, so that it is assumed that no crack will be formed in the cam lobe piece during the diametrical expansion (treatment) of the hollow shaft. Additionally, the internal stress generated in the cam lobe pieces of Examples 2-3 to 2-5 less in thickness W than that of Example 1 are also smaller than the tensile strength of Example 2-1. This demonstrates that no crack will be formed even if the thickness W of the cam lobe piece is small as 5 mm.

Additionally, as illustrated in FIGS. 1A and 1B, the cam lobe piece having the thickness W of 12.5 mm was formed with annular projections 4 which were located at the opposite side surfaces of the cam lobe piece, each annular projection 4 having the height C of 0.5 mm. This largely contributes to increasing a pressure receiving area thereby reducing the internal stress generated in the cam lobe piece during the diametrical expansion of the hollow shaft. It has been experimentally confirmed to exhibit such a stress reduction effect that the internal stress reduces by about 5% with annular projections 4 having the height of 0.5 mm. It is to be noted that if the height C of the annular projections is unnecessarily increased, there is a possibility that complication in production apparatus and lowering in productivity may be invited because of dividing a punch or the like of a die and tools so as to equally control pressures to be applied to the divided parts of the punch or the like for the purpose of preventing the density of the annular projections from becoming unequal to that of other sections during the warm compacting. Accordingly, it is preferable that the maximum value of the height C is not larger than about 20% of the thickness W of the cam lobe piece.

The entire contents of Japanese Patent Applications P2001-201610 (filed Jul. 3, 2001) and P2002-166873 (filed Jun. 7, 2002) are incorporated herein by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

TABLE 1

| | | | | | | | | Thickness | Lower | | | | | |
|---|---|---|---|---|---|---|---|---|---|---|---|---|---|---|
| | Composition | | | | | | | of base circle | limit of | | Surface | | Friction | Wear |
| | (wt %) | | | | | Impregnation | Density | section | density | Hardness | roughness | Expansion | torque | amount |
| | C | Cu | Mo | Ni | Fe | treatment | (g/cm³) | (mm) | (g/cm³) | HRA | Rpk (μm) | test | (kg-cm) | (μm) |
| Example 1-1 | 0.6 | — | 1.5 | 2 | Balance | Nil | 7.33 | 4.5 | 7.21 | 75 | 0.034 | No | 7.93 | 7 |
| | | | | | | | | | | | | crack | | |
| Example 1-2 | 0.6 | — | 1.5 | 2 | Balance | Nil | 7.17 | 5.6 | 6.80 | 73 | 0.062 | No | 8.01 | 10 |
| | | | | | | | | | | | | crack | | |
| Example 1-3 | 0.6 | — | 1.5 | 2 | Balance | Synthetic | 7.30 | 5.6 | 6.80 | 75 | 0.033 | No | 7.30 | 10 |
| | | | | | | resin | | | | | | crack | | |
| Example 1-4 | 0.6 | — | 1.5 | 2 | Balance | Synthetic resin | 7.30 | 5.6 | 6.80 | 75 | 0.045 | No | 7.06 | 7 |
| | | | | | | + | | | | | | crack | | |
| | | | | | | solid lubricant | | | | | | | | |
| Compar. | 0.6 | 3 | — | — | Balance | Nil | 7.01 | 4.5 | 7.21 | 65 | 0.111 | Crack | 8.10 | 504 |
| Example 1-1 | | | | | | | | | | | | formed | | |

TABLE 2

| | Composition | | | Sintering | | | | Tensile | Wear |
|---|---|---|---|---|---|---|---|---|---|
| | (wt %) | | | temperature | Heat | Hardness | Density | strength | amount |
| | Cu | C | Fe | (° C.) | treatment | HRA | (g/cm³) | (MPa) | ratio |
| Example 2-1 | 3.0 | 0.8 | Balance | 1120 | Carburizing hardening | 73 | 7.1 | 1030 | 1 |
| | | | | | and tempering | | | | |
| Example 2-2 | 1.5 | 0.8 | Balance | 1120 | Carburizing hardening | 73 | 7.2 | 990 | 0.9 |
| | | | | | and tempering | | | | |
| Compar. | 3.0 | 0.8 | Balance | 1120 | Carburizing hardening | 67 | 6.7 | 800 | 1.3 |
| Example 2-1 | | | | | and tempering | | | | |
| Compar. | 3.0 | 0.5 | Balance | 1120 | Carburizing hardening | 57 | 7.1 | 940 | 1.7 |
| Example 2-2 | | | | | and tempering | | | | |

TABLE 3

| | Thickness | Density | Generated |
|---|---|---|---|
| | (mm) | (g/cm³) | stress (MPa) |
| Example 2-1 | 12.5 | 7.1 | 694 |
| Example 2-3 | 10 | 7.1 | 710 |
| Example 2-4 | 7 | 7.1 | 824 |
| Example 2-5 | 5 | 7.1 | 935 |

What is claimed is:

1. A cam lobe piece of a built-up type camshaft having a hollow shaft fixedly inserted in a shaft opening of the cam lobe piece upon diametrical expansion of said hollow shaft, said cam lobe piece comprising:
a base circle section having the shaft opening; and
a cam lobe section formed integral with said base circle section,
wherein said cam lobe piece is formed of a ferrous sintered material which has a density (ρ) meeting the following equation:
ρ(g/cm³)≧−⅜×t+8.9
where t is a thickness (mm) of the base circle section in radial direction.

2. A cam lobe piece of a built-up type camshaft having a hollow shaft fixedly inserted in a shaft opening of the cam lobe piece upon diametrical expansion of said hollow shaft, said cam lobe piece comprising:
a base circle section having the shaft opening; and
a cam lobe section formed integral with said base circle section,
wherein said cam lobe piece is formed of a ferrous sintered material which is formed by sintering a compact having a density ranging from 7.1 to 7.4 g/cm³.

3. A cam lobe piece as claimed in claim 1, wherein the density of the ferrous sintered alloy is not lower than 7.25 g/cm³.

4. A cam lobe piece as claimed in claim 2, wherein the density of the ferrous sintered alloy is not lower than 7.25 g/cm³.

5. A cam lobe piece as claimed in claim 1, wherein the compact is formed under warm compacting of power material.

6. A cam lobe piece as claimed in claim 2, wherein the compact is formed under warm compacting of power material.

7. A cam lobe piece as claimed in claim 1, wherein said ferrous sintered material is subjected to heat treatment including hardening and tempering.

8. A cam lobe piece as claimed in claim 2, wherein said ferrous sintered material is subjected to heat treatment including hardening and tempering.

9. A cam lobe piece as claimed in claim 1, wherein said cam lobe piece has a cam outer surface having a hardness (HRA) of not lower than 60 upon being subjected to heat treatment.

10. A cam lobe piece as claimed in claim 2, wherein said cam lobe piece has a cam outer surface having a hardness (HRA) of not lower than 60 upon being subjected to heat treatment.

11. A cam lobe piece as claimed in claim 1, wherein said ferrous sintered material consists essentially of C in an amount ranging from 0.3 to 0.8% by weight, Mo in an amount ranging from 1.2 to 1.8% by weight, and balance being Fe and inevitable impurities.

12. A cam lobe piece as claimed in claim 1, wherein said ferrous sintered material consists essentially of C in an amount ranging from 0.3 to 0.8% by weight, Ni in an amount ranging from 1.7 to 2.3% by weight, Mo in an amount ranging from 1.2 to 1.8% by weight, and balance being Fe and inevitable impurities.

13. A cam lobe piece as claimed in claim 8, wherein said ferrous sintered material is formed by sintering a compact which is formed under warm compacting of power material in which Ni is partially alloyed with powder of alloy of Fe and Mo.

14. A cam lobe piece as claimed in claim 2, wherein said ferrous sintered material consists essentially of Cu in an amount ranging from 1. 5 to 4.0% by weight, C in an amount ranging from 0.7 to 1.0% by weight, and balance being Fe and inevitable impurities.

15. A cam lobe piece as claimed in claim 1, wherein said cam lobe piece has a cam outer surface having a surface roughness (Rpk) of not larger than 0.1 μm.

16. A cam lobe piece as claimed in claim 1, wherein said cam lobe piece is formed with pores exposed at a cam outer surface of said cam lobe piece, wherein said cam lobe piece further comprises synthetic resin with which the pores are impregnated.

17. A cam lobe piece as claimed in claim 1, wherein said cam lobe piece is formed with pores exposed at a cam outer surface of said cam lobe piece, wherein said cam lobe piece further comprises a mixture with which the pores are impregnated, said mixture containing synthetic resin, and solid lubricant dispersed in the synthetic resin.

18. A cam lobe piece as claimed in claim 2, further comprising an annular projection formed at an axially side surface of said base circle section, said annular projection axially projecting from the axially side surface of said base circle section, said annular projection being coaxial and located radially inside a base circle of said cam lobe piece.

19. A method of producing a cam lobe piece of a built-up type camshaft having a hollow shaft fixedly inserted in a shaft opening of the cam lobe piece upon diametrical expansion of said hollow shaft, the cam lobe piece including a base circle section having the shaft opening, and a cam lobe section formed integral with the base circle section, said method comprising:
compacting ferrous power material to form a compact;
sintering the compact to form a ferrous sintered material having a density (ρ) meeting the following equation:
ρ(g/cm³)≧−⅜×t+8.9
where t is a thickness (mm) of the base circle section in radial direction.

20. A method of producing a cam lobe piece of a built-up type camshaft having a hollow shaft fixedly inserted in a shaft opening of the cam lobe piece upon diametrical expansion of said hollow shaft, the cam lobe piece including a base circle section having the shaft opening, and a cam lobe section formed integral with the base circle section, said method comprising:
compacting ferrous power material to form a compact having a density ranging from 7.1 to 7.4 g/cm³; and
sintering the compact to form a ferrous sintered material for the cam lobe piece.
